(19) United States
(12) Patent Application Publication
(10) Pub. No.: US 2004/0187491 A1
(43) Pub. Date: Sep. 30, 2004

(54) Pump with hot oil shuttle valve

(76) Inventors: James S. Whitaker, Greeneville, TN (US); Xingen Dong, Greeneville, TN (US)

Correspondence Address: Joseph J. Pophal, PARKER - HANNIFIN CORPORATION, 6035 Parkland Boulevard, Cleveland, OH, 44124-4141, US

(21) Appl. No.: 10/807,602

(22) Filed: Mar. 24, 2004

Related U.S. Application Data
(60) Provisional application No. 60/458,109, filed on Mar. 26, 2003.

(51) Int. Cl. F16D 31/02

(52) U.S. Cl. 60/476

(57) ABSTRACT

A hydraulic pump for a closed-loop hydrostatic transmission circuit having an integrated shuttle valve for diverting hot fluid from the hydrostatic transmission circuit to a reservoir. The circuit operatively interconnects the hydraulic pump and a motor and includes a first line connecting a first port within the hydraulic pump to a first port within the motor and a second line connecting a second port within the hydraulic pump to a second port within the motor.

### CROSS-REFERENCE TO RELATED CASES

The present application claims the benefit of the filing date of U.S. Provisional Application Serial No. 60/458,109; filed Mar. 26, 2003, the disclosure of which is expressly incorporated herein by reference.

### FIELD OF THE INVENTION

The present invention relates to a hydrostatic transmission circuit having a hydraulic pump with an integrated shuttle valve.

### BACKGROUND OF THE INVENTION

Hydrostatic transmissions have many uses, including the propelling of vehicles, such as mowing machines, and offer a stepless control of the machine's speed. A typical hydrostatic transmission system includes a variable displacement main pump connected in a closed hydraulic circuit with a fixed displacement hydraulic motor. For most applications, the pump is driven by a prime mover, such as an internal combustion engine or an electrical motor, at a certain speed in a certain direction. In hydrostatic applications, an over center variable displacement axial piston pump is used. The displacement of the pump is determined by the size and number of pistons, as well as the stroke length. A control handle enables the operator to control the direction and amount of flow from the pump. When an operator pushes the handle in one direction, the pump delivers flow for one direction of motor operation. When an operator pulls the handle in the opposite direction, the pump delivers flow for the opposite direction.

Changing the displacement of the pump will change its output flow rate, which controls the speed of the motor. Pump outflow can be reversed, thus reversing the direction of the motor. In a vehicle, the motor is connected directly or through suitable gearing to the vehicle's wheels or tracks. Acceleration and deceleration of the transmission are controlled by varying the displacement of the main pump from its neutral position. The present invention relates generally to the hydrostatic transmission and, more specifically, to the hydraulic pump which has an integrated valve for cooling the hydraulic fluid within closed loop hydraulic circuit.

The closed hydraulic circuit includes a first conduit connecting the main pump outlet with the motor inlet and a second conduit connecting the motor outlet with the pump inlet. Either of these conduits may be the high pressure line depending upon the direction of pump displacement from neutral. A charge pump is added to the hydraulic circuit in order to charge the closed-circuit with hydraulic fluid through check valves, thus making up for possible lost fluid due to internal leakage. Other valves can be added to the closed-circuit. For example, high pressure relief valves can be used to protect the hydrostatic transmission from overloading during its operation, bypass valves can be used to allow oil to be routed from one side of the transmission to the other side without significant resistance, and hot-oil shuttle valves can be used to reduce the loop temperature by connecting the low pressure side of the closed loop to a drain, thus allowing replenishment with fresh, cooled replacement hydraulic fluid. The drain leads to a heat exchanger that cools the hot oil before depositing the oil in a reservoir tank. The charge pump provides the oil replenishment when it draws the cooled oil through a filter from the reservoir tank.

It is necessary for the drain line to be connected with a component within the closed loop circuit. Prior art designs have added drain lines to manifolds which are attached onto the pump or the motor. These drain lines add further componentry to the circuit which provides leak points, size and expense to the system. An example of such a design is shown in prior art U.S. Pat. No. 6,062,405 to Pech et al. Certain motors and pumps don't have manifolds so adding a manifold further complicates the circuit. It is advantageous to avoid adding componentry to the system.

Other prior art designs add a case drain line to the motor. Motors and pumps have housings, or cases, that capture leaking fluid and return such fluid to the reservoir through the case drain line. Typically these motors are three pressure stage motors. If the motor used is not a three-pressure stage motor and, for example, is a two-pressure stage motor than a case drain line orifice is not provided. In order to supply a case drain line, a separate manifold (discussed above) is then needed. This can be disadvantageous since the added manifold provides more leak paths, size and expense to the system. As can be seen, it is advantageous to use an existing case drain port for connection with the case drain line. Since the purpose of the hot-oil shuttle valve is to return hot oil to the reservoir tank through a drain line, it simplifies the system to use the component that is connected with the case drain line.

### SUMMARY OF THE INVENTION

The present invention provides improvements with hydrostatic transmission circuits having a hydraulic pump fluidly connected with a motor. According to one feature of the present invention, the hydrostatic transmission comprises a hydraulic circuit operatively interconnecting a variable displacement main pump with a hydraulic motor. The hydraulic circuit includes a first line connecting a first port within the main pump to a first port within the hydraulic motor and a second line connecting a second port within the main pump to a second port within the hydraulic motor. The hydrostatic transmission also includes a charge pump operatively connected to the circuit and a reservoir. The variable displacement pump has a first input passage fluidly connected to the hydraulic circuit first line, a second input passage fluidly connected to the hydraulic circuit second line, an output passage fluidly connected to a pump case drain line that leads to the reservoir, and a valve bore integrated within the pump in fluid communication with the first input passage, the second input passage and the output passage, for receiving a hot oil shuttle valve. The hot oil shuttle valve includes a valve spool, adapted for sealing movement within the spool bore, having a first end portion, a second end portion, and a connecting portion having a cross sectional area smaller than that of the first and second end portions and in fluid communication with at least a portion of the output passage at all times. The valve spool is longitudinally movable, via fluid pressure, within the spool bore from a neutral position to one of a first and second position. The fluid pressure forces, acting on the first and second end portions, are approximately equal in the valve spool neutral position. The fluid pressure forces acting on the first end portion are greater than the fluid pressure forces acting on the second end portion in the first position. The fluid pressure forces acting on the first end portion are less than the fluid pressure forces acting on the second end portion in the second position. The second input passage communicates hot oil fluid to the output passage while the valve spool is in the first position and the first input passage communicates hot oil fluid to the output passage while the valve spool is in the second position.

Another feature of the noted circuit has the pump having a case with at least one orifice for connection with a case drain line. A further feature of the noted circuit has the motor being a two-stage motor. Still another feature of the noted circuit has the hot oil shuttle valve taking the form of a spool valve.

According attribute of the present invention includes providing a hydraulic pump for a closed-loop hydrostatic transmission circuit having an integrated shuttle valve for diverting hot fluid from the hydrostatic transmission circuit to a reservoir, where the circuit operatively interconnecting the hydraulic pump with a motor.

Another feature of the noted hydraulic pump has the circuit including a first line connecting a first port within the hydraulic pump to a first port within the motor and a second line connecting a second port within the hydraulic pump to a second port within the motor. Still a further feature of the noted hydraulic pump has the shuttle valve being housed within a bore in the pump, the bore being fluidly connected to a first passage, a second passage and a third passage. The first passage is fluidly connected to the first line in the closed-loop hydrostatic transmission circuit, the second passage is fluidly connected to the second line in the closed-loop hydrostatic transmission circuit, and the third passage is fluidly connected to a case drain line connecting the pump to the reservoir. The first passage has fluid flow therethrough when the pressure in the first line is less than the pressure in the second line. The second passage has fluid flow therethrough when the pressure in the second line is less than the pressure in the first line. The third line has fluid flow therethrough when either the pressures in the first and second lines are not equal.

Still, yet another feature of the noted hydraulic pump has the shuttle valve housed within a bore in the pump and being able to reciprocatingly move from a centered position, in which the pressure in the first line is equal to the pressure in the second line, to a first position, in which the pressure in the first line is greater than the pressure in the second line, and to a second position, in which the pressure in the first line is less than the pressure in the second line. Still a further feature of the noted hydraulic pump has the hot fluid passing from the second line to the reservoir for cooling when the shuttle valve is in the first position and the hot fluid passes from the first line to the reservoir for cooling when the shuttle valve is in the second position. Another attribute of the noted hydraulic pump has the pump being of the variable displacement variety. Further features and advantages of the present invention will become apparent to those skilled in the art upon review of the following specification in conjunction with the accompanying drawings.

### BRIEF DESCRIPTION OF THE DRAWINGS

FIG. 1 is a hydraulic schematic of the present invention showing a hydrostatic transmission closed-loop circuit with a pump having an integrated shuttle valve.

FIG. 2 is a hydraulic schematic of a typical prior art hydrostatic transmission closed-loop circuit.

FIG. 3 is a hydraulic schematic of the present invention similar to FIG. 1 but with the pump in the neutral position.

FIG. 4 is an elliptical cross-sectional view of the actual design of the hot oil shuttle valve schematically illustrated in FIG. 1 showing the hot oil shuttle valve with integrated orifices and springs on both ends of the valve in a neutral position.

FIG. 5 is a view, similar to that of FIG. 4, but showing the position of the shuttle valve when the fluid pressure in line 43 is greater than the fluid pressure in line 45.

FIG. 6 is a view, similar to that of FIG. 4, but showing the position of the shuttle valve when the fluid pressure in line 45 is greater than the fluid pressure in line 43.

FIG. 7 is a frontal view of the pump according to the present invention.

FIG. 8 is a sectional view of the area of the pump which houses the hot oil shuttle valve taken along the line 8-8 in FIG. 7.

FIG. 9 is a sectional view of the pump taken along the line 9-9 in FIG. 7.

### DETAILED DESCRIPTION OF THE INVENTION

The present invention relates to a hydraulic pump, and in particular to a light duty pump used, for example, in a closed-loop hydrostatic transmission circuit. The pump is of the axial piston design and combines with a motor and other accessories to comprise the hydrostatic transmission. The pump is a variable displacement pump and is typically used in turf equipment propulsion systems. As is well known in the art, a variable displacement pump enables the equipment to smoothly transition from neutral to forward or reverse.

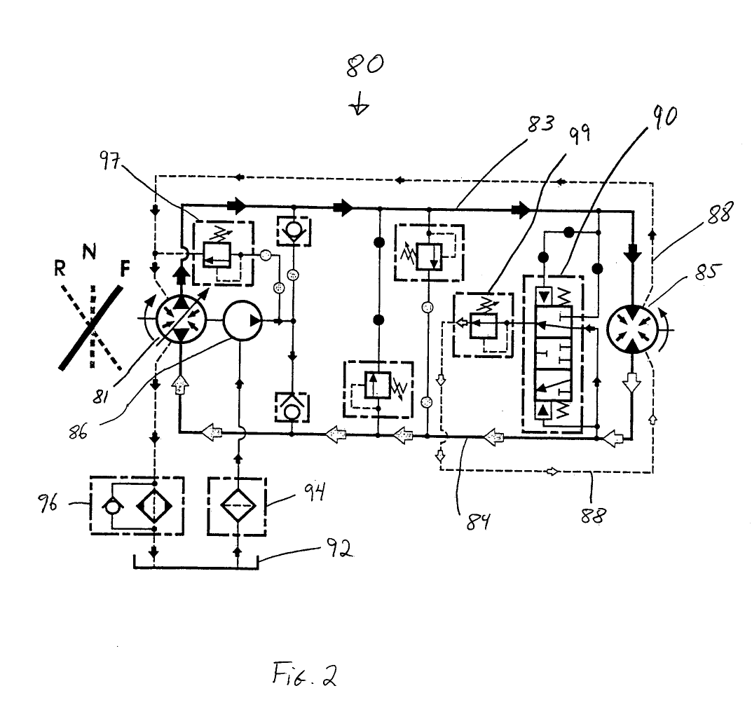

FIG. 2 shows a schematic of a typical prior art closed-loop hydrostatic transmission circuit 80 consisting of a variable displacement pump 81 and a fixed displacement motor 85 connected to each other by lines 83 and 84. An input shaft (not shown) for pump 81 is driven by a prime mover (not shown), such as an internal combustion engine or an electrical motor, at a predetermined speed in a predetermined direction. Changing the displacement of pump 81 changes its output flow rate, which controls the speed of motor 85. Moving the swashplate or yoke (not shown) of pump 81 overcenter will automatically reverse the flow out of pump 81, thus reversing the direction of motor 85. Depending on the direction of the overcenter movement of the pump swashplate (or yoke), line 83 (or line 84) can be a high pressure supply line or a low pressure return line.

A charge pump 86, also driven via an input shaft, supplies additional hydraulic fluid to closed-loop circuit 80 at the rate of approximately 10-30% of the flow rate that main pump 81 can deliver. Charge pump 86 draws fluid from a reservoir 92 which passes through a filter 94 and replenishes closed loop 80 with fluid to compensate for any possible flow loss due to internal leakage. A charge pump relief valve 97 is used to provide a relief path to reservoir 92 when more than required flow from charge pump 86 cannot enter closed loop 80.

FIG. 2 shows main pump 81 in the forward position such that hydraulic fluid flows through line 83 to motor 85, causing same to rotate. A hot-oil shuttle valve 90 is shown integrated within motor 85. The integration of the shuttle valve within the motor of a closed-loop circuit is common, specifically with motors having attached case drain lines 88. Such motors, for example three pressure zone motors, are well known in the art. Hot-oil shuttle valve 90 is provided to reduce the loop temperature by connecting the low pressure side of closed-loop circuit 80 to case drain line 88. Any resistance created by the fluid flowing through motor 85 creates pressure which causes shuttle valve 90 to shift, opening the low pressure side (at low pressure line 84) of the closed loop to shuttle valve 90. Shuttle valve 90 allows a maximum possible percentage of the hot oil discharging from motor 85 to flow back to reservoir 92 for cooling and filtering, and replaces the discharged hot oil with cooled, filtered oil from charge pump 86. Specifically, about 10% of the oil exhausted from motor 85 flows through low pressure line 84 and enters shuttle valve 90. From shuttle valve 90 the fluid enters a forward/reverse charge pressure relief valve 99. Relief valve 99 maintains a certain amount of fluid pressure on the low pressure side of circuit 80. Since forward/reverse charge pressure relief valve 99 (which functions for forward and reverse) is in parallel with charge pump relief valve 97 (which functions for neutral), valve 97 is set at a pressure higher than that of relief valve 99 thus allowing a maximum possible flow to pass through shuttle valve 90. This fluid joins other fluid, such as any created from internal leakage of motor 85 (caused by high pressure and lubrication that is in the motor case), in case drain line 88 downstream of motor 85. Together this fluid flows through pump 81 housing and is cooled by a heat exchanger 96 before entering reservoir 92.

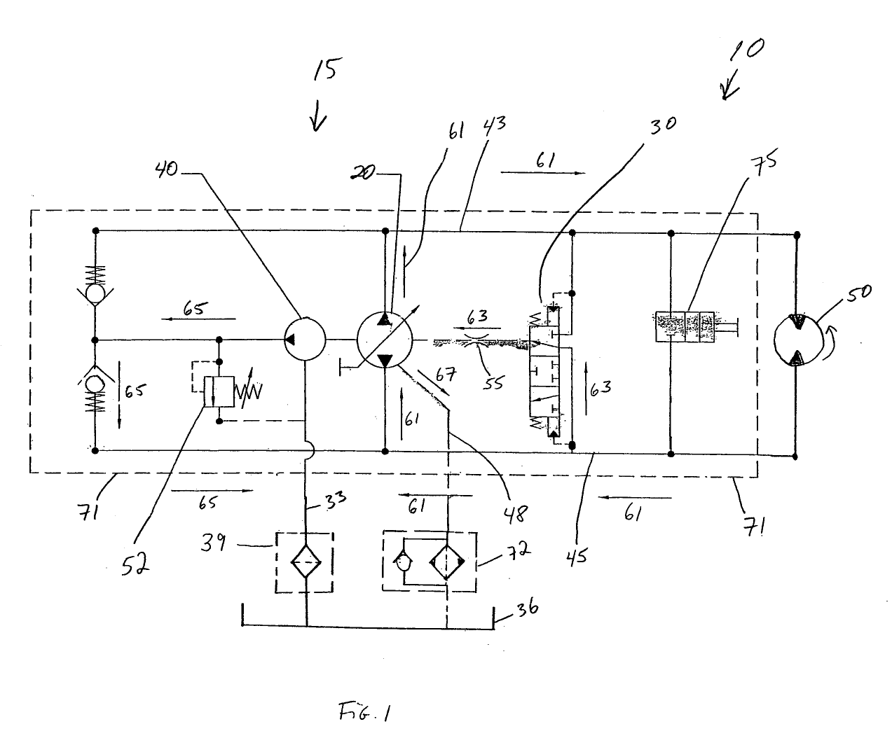

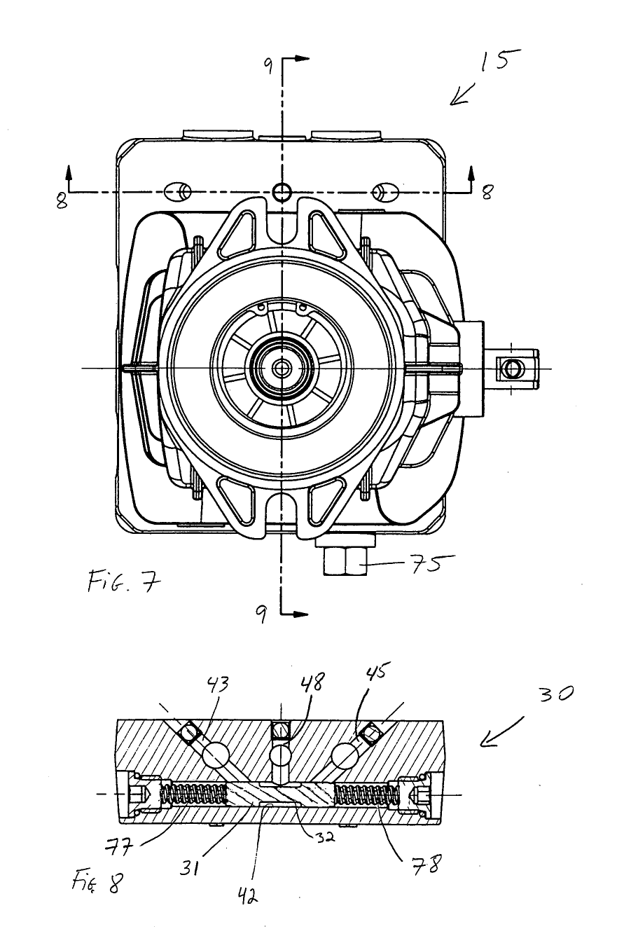

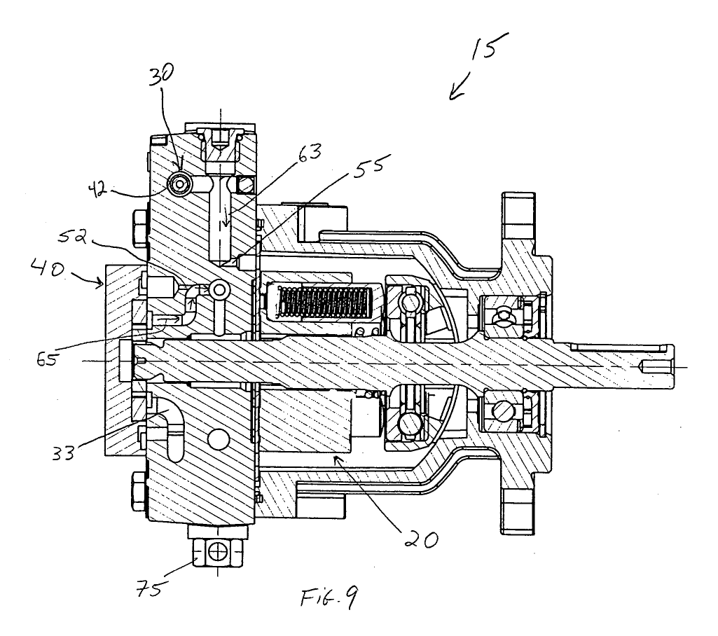

Referring to FIGS. 1 and 7-9, the present invention relates to a closed-loop hydrostatic transmission circuit 10 similar to that described above and also provides a hot oil shuttle valve 30 within circuit 10 for the purpose of removing heat from the closed-loop. However, the placement of shuttle valve 30 in the present invention differs from that shown in FIG. 2. In the present invention, a pump unit 15, comprising the componentry within dotted line 71, houses hot oil shuttle valve 30 rather than having same integrated within motor 50, as the prior art has done. The actual placement and location of hot oil shuttle valve 30 within pump unit 15 is best shown in FIGS. 8 and 9. As discussed above, a closed-loop hydrostatic transmission circuit, including circuit 10, consists of a variable displacement pump 20 and a fixed displacement motor 50 connected to each other by lines 43 and 45. Also discussed above and well known in the art, hot oil shuttle valves divert hot oil back to the reservoir (for cooling) and need a low pressure case drain line for such return. Closed-loop circuit 10 utilizes an existing case drain line 48 fluidly connected with pump 20 and positions hot oil shuttle valve 30 within pump unit 15.

Operation of the present invention will now be discussed. Referring to FIG. 3, upon start-up and while the machine/vehicle utilizing the hydrostatic transmission is in neutral, fluid flows from a reservoir 36, through a suction filter 39, through a line 33 connecting reservoir 36 to a charge pump 40, and into charge pump 40. Flow from charge pump 40 enters closed-loop circuit 10 via a line 35, passes through dual charge check valves 27, 28 and charges (fills) circuit 10 with fluid. Specifically the fluid fills line 43 from pump 20 to motor 50 and line 46 from motor 50 to pump 20. Shuttle valve 30 remains centered since there is equal pressure in lines 43 and 45. This fluid flow is represented by arrows 57. When circuit 10 is entirely full of fluid, flow from charge pump 40 diverts through a neutral charge pressure relief valve 52 and returns to charge pump inlet.

Referring to FIG. 1, in order to move the machine/vehicle in the forward or reverse direction, the swashplate (not shown) of pump unit 15 is moved either side of center. As soon as the swashplate moves off the center position, fluid flows out of pump 20 in the direction indicated by arrow 61, through line 43 (which becomes the high pressure side of the closed-loop) to motor 50 causing it to rotate. The resistance created by the fluid flow through motor 50 begins to build pressure within line 43 and causes shuttle valve 30 to shift towards line 45 thus opening shuttle valve 30 to line 45. A portion (indicated by arrow 63) of the flow exiting motor 50 through line 45 enters shifted shuttle valve 30. The remaining flow 61 continues past shuttle valve 30 and returns to pump 20.

Since hydrostatic transmission circuit 10 is closed, it is necessary to remove a portion (e.g. 10-15%) of the fluid for cooling and filtering on a continuous cycle. Shuttle valve 30 creates a secondary flow path (as indicated by arrows 63) so the maximum possible fluid can be cooled and filtered. Flow 63 enters the housing of pump unit 15, combines with any internal leakage of pump 20 and other componentry, and exits pump unit 15 as flow 67. A dotted line 71 is shown surrounding the majority of components integrated into the hydrostatic pump unit. All leakage within line 71 will travel into the case of pump unit 15 and returns to reservoir 36 through case drain line 48. Therefore all leakage from charge pump 40, all relief valves, etc. inside dotted line 71 enters the case of pump unit 15 for cooling and filtering before returning to circuit 10. Pump unit 15 has a housing or case with a port for connection with case drain line 48. Flow 67 travels through case drain line 48 and enters (and is cooled by) a heat exchanger 72 before returning to reservoir 36. The equivalent amount of fluid leaving loop 10, indicated by flow arrow 67, is replenished into loop 10 by charge pump 40. This replenishment fluid is indicated by flow arrow 65. Replenishment fluid 65 combines with fluid 61 leaving motor 50 (and not flowing through shuttle valve 30) and re-enters pump 20 for another loop. The hot fluid flow 67 leaving pump unit 15 through case drain 48 is cooled by heat exchanger 72 and enters reservoir 36. This same amount of fluid is re-introduced into loop 10 by charge pump 40 (through line 33) after it is cleaned by filter 39. The cool fluid reintroduced by charge pump 40 also cools off the case of pump unit 15 when it travels through the pump inlet. Replenishment fluid 65 to the low pressure side also prevents cavitation, which may occur at pump 20 inlet from a lack of fluid pressure.

Since hot-oil shuttle valve 30 is utilized for cooling and cleaning fluid in a closed-loop, it needs to be connected to case drain line 67 which returns fluid to reservoir 36 for cooling and cleaning. As is well known in the art, most motors and pumps have cases, or housings. Case drain lines connected to motors, such as three zone motors, are well known in the art. The present invention is primarily intended for closed-loop circuits having a two-zone motor which do not have case drains. If the shuttle valve was separate from both the motor and pump, a separate manifold would be needed. This would add componentry and conduit that is undesirable since this adds possible leak paths and expense to the closed-loop. By integrating shuttle valve 30 into pump unit 15, closed loop circuit 10 is more compact, has less leak points, less componentry and less plumbing.

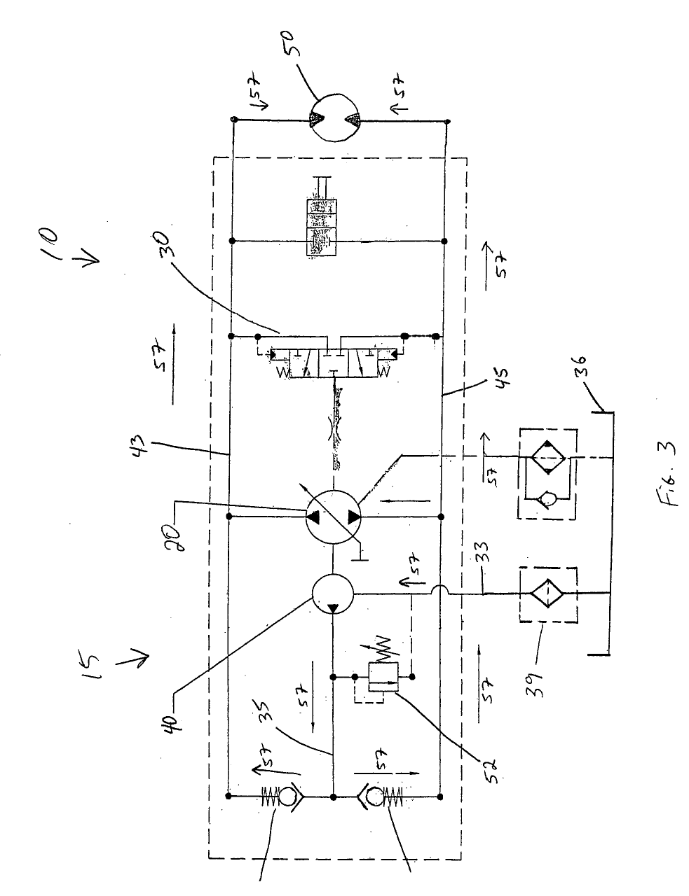

Referring to FIGS. 4-6 and 8, shuttle valve 30 is shown as a spool type shuttle valve. Shuttle valve 30 has a spool 31 sealingly reciprocatable within a bore 42, having a mid-portion 32 with a smaller cross-section. The opposite end of mid-portion 32 provides a path for fluid communication between lines 43 and 45 with line 48. Shuttle valve 30 utilizes springs 77 and 78, which can be compression springs, on opposite ends thereof. As described above, shuttle valve 30 communicates the low pressure side (line 45 in FIG. 1) with case drain line 48 when the swashplate of pump 20 is in the forward position. FIG. 4 details the centered position of shuttle valve 30 when closed-loop circuit 10 is in neutral. The pressure within lines 43 and 45 are equal and the force exerted by springs 77 and 78 is equal, so valve 30 remains centered. Referring to FIG. 8, the center position is also shown. As can be seen, flow from lines 43 and line 45 can not reach line 48 since spool midportion 32 is centered.

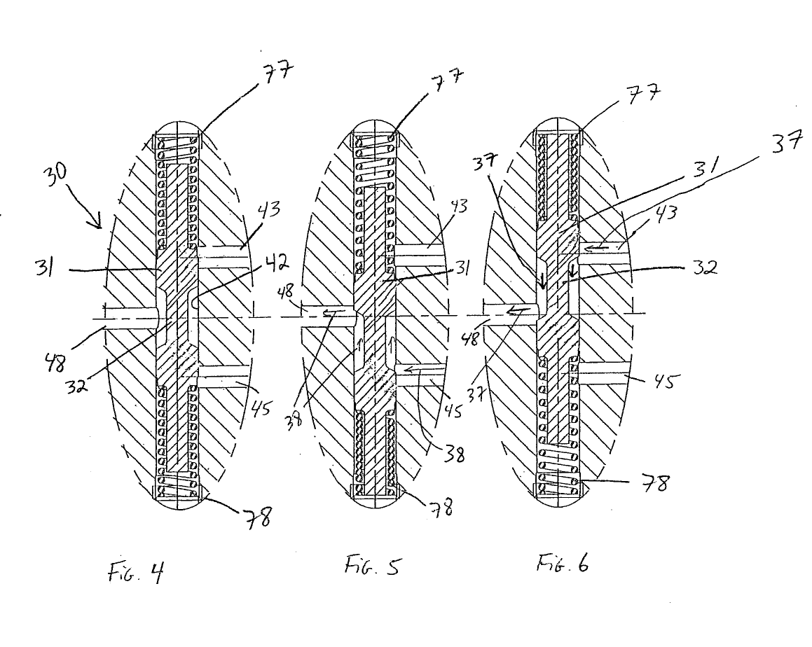

When the swashplate of pump 20 is moved into the forward position, the pressure in line 43 exceeds the pressure in line 45. Referring to FIG. 5, spool 31 shifts downwardly towards low pressure line 45, compressing spring 78 and opening spool midportion 32 to both lines 45 and 48. This allows fluid communication, as indicated by arrow 38, from low pressure line 45 into case drain line 48. With spool 31 in the FIG. 5 position, low-pressure line 45 can continuously supply hot oil to heat exchanger 72.

Referring to FIG. 6, when the swashplate of pump 20 is moved into the reverse position, the pressure in line 45 exceeds the pressure in line 43. Spool 31 shifts upwardly towards line 43, compressing spring 77 and opening spool midportion 32 to both line 43 and pump case drain line 48. This allows fluid communication from line 43 into case drain line 48, indicated by flow arrow 37, so the hot fluid can reach heat exchanger 72 and reservoir 36.

Referring again to FIGS. 1 and 9, in certain applications, closed-loop circuit 10 will also have a bypass valve 75 positioned between lines 43 and 45 in order to transfer oil from one line to the other. The use of bypass valve 75 enables motor 50 to turn over with little resistance when it is desirable, for example, to move the machine/vehicle for a short distance without operating the transmission.

Closed-loop circuit 10 can also utilize a fixed restriction orifice 55 within shuttle valve 30 in order to ensure that the low pressure side of the loop maintains a desirable pressure so that fluid flows into the reservoir which is at ambient pressure. It should be noted that a pressure relief valve, such as that shown in FIG. 2 (as relief valve 99), could be used to replace orifice 55.

When the swashplate (not shown) of pump 20 is returned to its neutral position, flow through closed-loop circuit 10 ceases immediately. Shuttle-valve 30, being spring-centered to the neutral position, immediately returns to the position shown in FIGS. 3 and 4. Flow from charge pump 40 travels through neutral charge pressure relief valve 52 and maintains charge pressure within circuit 10. While in neutral, the transmission isn't generating significant heat so heat dissipation, via shuttle valve 30, isn't needed. Moving the swashplate of pump 20 over-center (opposite of that described above) will cause fluid to flow out of the opposite side of pump 20 (and opposite of fluid arrows 61). Reversing the fluid flow in closed-loop circuit 10 causes motor 50 to reverse. The function of the system in reverse is a mirror image of the function of the system in forward.

It should be noted that the present invention is not limited to the specified preferred embodiments and principles. Those skilled in the art to which this invention pertains may formulate modifications and alterations to the present invention. These changes, which rely upon the teachings by which this disclosure has advanced, are properly considered within the scope of this invention as defined by the appended claims.

What is claimed is:

1. A hydraulic system for use in a hydrostatic transmission comprising in combination:
a variable displacement main pump;
a hydraulic motor;
a hydraulic circuit operatively interconnecting said main pump and said motor including a first line connecting a first port within said main pump to a first port within said hydraulic motor and a second line connecting a second port within said main pump to a second port within said hydraulic motor;
a charge pump operatively connected to said circuit and a reservoir; and
wherein said variable displacement pump has:
a first input passage fluidly connected to said hydraulic circuit first line;
a second input passage fluidly connected to said hydraulic circuit second line;
an output passage fluidly connected to a pump case drain line that leads to said reservoir;
a valve bore integrated within said pump in fluid communication with said first input passage, said second input passage and said output passage, for receiving a hot oil shuttle valve;
said hot oil shuttle valve including a valve spool, adapted for sealing movement within said spool bore, having a first end portion, a second end portion, and a connecting portion having a cross sectional area smaller than that of the first and second end portions and in fluid communication with at least a portion of said output passage at all times, said valve spool being longitudinally movable, via fluid pressure, within said spool bore from a neutral position to one of a first and second position, wherein the fluid pressure forces, acting on the first and second end portions, are approximately equal in said valve spool neutral position, the fluid pressure forces acting on said first end portion being greater than the fluid pressure forces acting on said second end portion in the first position, and the fluid pressure forces acting on said first end portion being less than the fluid pressure forces acting on said second end portion in the second position, said second input passage communicating hot oil fluid to said output passage while said valve spool is in said first position and said first input passage communicating hot oil fluid to said output passage while said valve spool is in said second position.

2. A hydraulic system for use in a hydrostatic transmission comprising in combination:
a main pump;
a hydraulic motor;
a hydraulic circuit operatively interconnecting said main pump and said motor including a first line connecting a first port within said main pump to a first port within said hydraulic motor and a second line connecting a second port within said main pump to a second port within said hydraulic motor;
a charge pump operatively connected to said circuit and a reservoir; and
wherein an improvement comprises said variable displacement pump having an integrated hot oil shuttle valve for diverting a portion of fluid flowing through said hydraulic circuit to said reservoir.

3. The hydraulic system in claim 2 wherein said main pump is a variable displacement pump.

4. The hydraulic system in claim 3 wherein said hot oil shuttle valve diverts fluid from said second line to said reservoir when the pressure in said first line is greater than the pressure in said second line and diverts fluid from said first line to said reservoir when the pressure in said first line is less than the pressure in said second line.

5. The hydraulic system in claim 3 wherein said pump has a case with at least one orifice for connection with a case drain line.

6. The hydraulic system in claim 3 wherein said motor is a two-stage motor.

7. The hydraulic system in claim 3 wherein said hot oil shuttle valve takes the form of a spool valve.

8. A hydraulic pump for a closed-loop hydrostatic transmission circuit having an integrated shuttle valve for diverting hot fluid from said hydrostatic transmission circuit to a reservoir, said circuit operatively interconnecting said hydraulic pump with a motor.

9. The hydraulic pump as in claim 8 wherein said circuit includes a first line connecting a first port within said hydraulic pump to a first port within said motor and a second line connecting a second port within said hydraulic pump to a second port within said motor.

10. The hydraulic pump in claim 9 wherein said shuttle valve is housed within a bore in said pump, said bore is fluidly connected to a first passage, a second passage and a third passage, said first passage is fluidly connected to said first line in said closed-loop hydrostatic transmission circuit, said second passage is fluidly connected to said second line in said closed-loop hydrostatic transmission circuit, said third passage is fluidly connected to a case drain line connecting said pump to said reservoir, said first passage has fluid flow therethrough when the pressure in said first line is less than the pressure in said second line, said second passage has fluid flow therethrough when the pressure in said second line is less than the pressure in said first line, said third line has fluid flow therethrough when either the pressures in said first and second lines are not equal.

11. The hydraulic pump in claim 9 wherein said shuttle valve is housed within a bore in said pump and can reciprocatingly move from a centered position, in which the pressure in said first line is equal to the pressure in said second line, to a first position, in which the pressure in said first line is greater than the pressure in said second line, and a second position, in which the pressure in said first line is less than the pressure in said second line.

12. The hydraulic pump as in claim 11 wherein the hot fluid passes from said second line to said reservoir for cooling when said shuttle valve is in said first position and the hot fluid passes from said first line to said reservoir for cooling when said shuttle valve is in said second position.

13. The hydraulic pump as in claim 8 wherein said motor is a two-pressure stage motor

14. The hydraulic pump as in claim 8 wherein said hydraulic pump is a variable displacement pump.
